(19) United States
(12) Patent Application Publication
(10) Pub. No.: US 2014/0160230 A1
(43) Pub. Date: Jun. 12, 2014

(54) Multi Channel and Wide-Angle Observation System

(71) Applicants: CHIH-WEI KUO, Taichung City (TW); CHIEN-YUAN HAN, New Taipei City (TW); ER-LIANG JIAN, Dayuan Township (TW); MIN-FANG LO, Zhongli City (TW)

(72) Inventors: CHIH-WEI KUO, Taichung City (TW); CHIEN-YUAN HAN, New Taipei City (TW); ER-LIANG JIAN, Dayuan Township (TW); MIN-FANG LO, Zhongli City (TW)

(73) Assignee: CHUNG SHAN INSTITUTE OF SCIENCE AND TECHNOLOGY, ARMAMENTS BUREAU, M.N.D.

(21) Appl. No.: 13/707,858

(22) Filed: Dec. 7, 2012

(51) Int. Cl. H04N 5/232

(52) U.S. Cl. CPC H04N 5/23296
USPC 348/36

(57) ABSTRACT

A multi channel and wide-angle observation system includes at least two lens modules, at least two polarization units, at least two polarization control units, at least two transmittance control units and a spectroscope to form a multiple structure, which utilizes the light polarization characteristics to control the light propagation, to control switching different channel to form an optical image in accordance with the timing control unit, and then to synthesize the images by an image processing unit. Since each channel of the system has different visual angles for capturing images, a wide-angle image can be got via the image synthesis and a light transmittance adjustment cab be processed via the transmission rate control module, so as to adjust the light intensity from different incident directions to balance the vision lightness of the wide-angle image.

### BACKGROUND OF THE INVENTION

1. Field of the Invention

This invention is related to a multi channel and wide-angle observation system, and more particular to a multi channel imaging system having a time switching mechanism for capturing wide-angle image.

2. Description of Related Art

Generally, the wide-angle photography skills are developed for capturing the scene so as to allow human eyes to see. The skills also highlight the integrity of the scenery, or even create a broader vision than the human eyes do, which allows the application of the wide-angle lens to be broader and broader, such as the technique of image investigation in military, expanding the scope of investigation and avoiding any omission of important image information. Another example is to capture an image in the space by using a Hubble Space Telescope. Since the galaxy has a vast scope, it is necessary to use a wide-angle technology to capture the whole image. In addition, the applications such as a popular car video recorder or a Google-street-view-shooting etc. need to use the wide-angle technology. Therefore, it is to be noted that the wide-angle technology is important to the image records.

A plurality of aspheric lenses are used in the current conventional technology, wherein the curvature of each lens is calculated from a specific formula, and the configuration sequence of these lenses is arranged according to the image-taking directions of the object, the wide-angle lens is therefore developed. However, this technology is difficult in producing aspheric lens, and the yield thereof is also difficult to be controlled. Also, the curvature and the structure of the aspheric lens need to be re-designed when the length of the lens changes, which will cause a high production cost.

Another prior art is to install a camera module in a vehicle to change the direction of the image-taking via a first motor and a second motor. The first motor is rotated for an azimuth angle, while the second motor is for an elevation angle, which allows the camera module to have an all-dimensional image effect. However, this technology takes a certain time to move the motors, which is inconvenient in usage and the structural stability must also be available for testing, otherwise, image distortion is easily occurred.

Although currently some multi-channel optical imaging methods have been developed to reduce the aforementioned problems, the optical imaging and image processing of different channels can not be synchronized, resulting in the motion blur on display, and when the light intensity of the different optical channels is different, discontinuous lighting issue occurs on the display screen.

Therefore, how to overcome the above mentioned shortcomings is the issue the industry needs to resolve.

### SUMMARY OF THE INVENTION

The objective of the present invention is to provide a multi channel and wide-angle observation system, which controls the imaging path of the channel by the timing control and the light intensity of the channel via an optical transmittance, so that the image is continuous and clear.

In order to achieve the above objective, this present invention includes a first image capture module capturing a first image for zooming, optical modulating and lighting control, a second image capture module capturing a first image for zooming, optical modulating and lighting control, a polarization beam splitter disposed for distributing the first image and the second image, a photosensitive module receiving one of the first image and the second image to generate an image signal, and a control module for processing the image signal.

Further, the first image capture module includes a first lens unit, a first polarization means, a first polarization control unit and a first transmittance control unit. The second image capture module includes a second lens unit, a second polarization unit, a second polarization control unit and a second transmittance control unit. The control module includes a time control unit, a lighting control unit and an image processing unit.

The first lens unit and the second lens unit are used to capture a wide-view image. The first polarization control unit, the second polarization control unit, the first transmittance control unit and the second transmittance control unit are used as the structures of a liquid crystal optical switch to effectively adjust the intensity of light and convert the polarization of the incident light source, and in coordination with the switching of the multi channel via the timing control unit, so that the images in the multi channel can be formed in the photosensitive module (as CCD sensor) to achieve a wide-angle image with a balanced vision lightness on a display module and without blurry image.

### BRIEF DESCRIPTION OF THE DRAWINGS

The invention, as well as its many advantages, may be further understood by the following detailed description and drawings in which:

FIG. 1 is a schematic diagram showing a multi channel and wide-angle observation system of the present invention;

FIG. 2a is a schematic diagram showing an image capture via the first image capture module; and

FIG. 2b is a schematic diagram showing another image capture via the second image capture module.

### DETAILED DESCRIPTION OF THE INVENTION

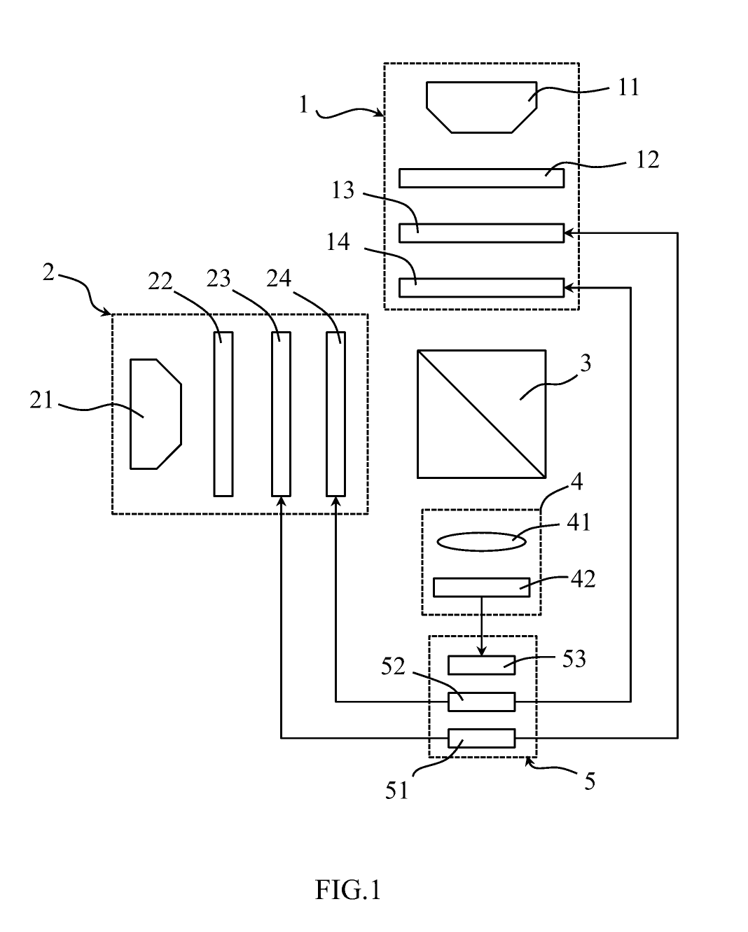

With reference to FIG. 1, the multi channel and wide-angle observation system provided by a preferred embodiment of the present invention includes a first image capture module 1, a second image capture module 2, a polarization beam splitter 3 (PBS), a photosensitive module 4 and a control module 5.

The first image capture module 1 and the second image capture module 2 respectively capture an image A as a first image and an image B as a second image.

The first image capture module 1 captures the image A for zooming (image A′), linear polarizing (image A″), polarization modulating (image A′″) and lighting control, then zooming the image A (image A″″). The second image capture module 2 captures the image B for zooming (image B′), linear polarizing (image B″), polarization modulating (image B′″) and lighting control, then zooming the image B (image B″″).

The polarization beam splitter 3 is located between the imaging end of the first image capture module 1 and the imaging end of the second image capture module 2, which is used to receive one of the images A″″ and B″″ and to guide either the images A″″ or B″″ according to the polarized direction.

The photosensitive module 4 receives one of the image A″″ and the image B″″ for photosensitive imaging, and to generate an image signal.

The control module 5 includes a timing control unit 51, a lightness control unit 52 and an image processing unit 53, and is electrically connected to the photosensitive module 4 to receive the image signal.

In the preferred embodiment, the first image capture module 1 includes a first lens unit 11, a first polarization unit 12 (polarizer), a first polarization control unit 13 and a first transmittance control unit 14.

In the preferred embodiment, the second image capture module 2 includes a second lens unit 21, a second polarization unit 22 (polarizer), a second polarization control unit 23 and a second transmittance control unit 24.

In the preferred embodiment, the first lens unit 11 includes a plurality of lenses (not shown in the figure), having a first optical axis, and zooming the image A to generate the image A′.

In the preferred embodiment, the first polarization unit 12 is located at the imaging side (should be side) of the first lens unit 11 along the first optical axis, and filtering the image A′ polarization to produce the image A″.

In the preferred embodiment, the first polarization control unit 13 is located at the imaging side of the first polarization unit 12 along the first optical axis, optionally transmitting and rotating the image A″ to produce the images A′″.

In the preferred embodiment, the first transmittance control unit 14 is located at the imaging side of the first polarization control unit 13 along the first optical axis, controlling the lightness of the image A′″ to produce the image A″″ via adjustment of the light transmittance.

In the preferred embodiment, the second lens unit 21 includes a plurality of lenses (not shown in the figure), and has a second optical axis, zooming the image B to generate the image B′.

In the preferred embodiment, the second polarization unit 22 is located at the imaging side of the second lens unit along the second optical axis, filtering the image B′ polarization to generate the image B″.

In the preferred embodiment, the second polarization control unit 23 is located at the imaging side of the second polarization unit 22 along the second optical axis, optionally transmitting and rotating the image B″ to produce the images B′″.

In the preferred embodiment, the second transmittance control unit 24 is located at the imaging side of the second polarization control unit 22 along the second optical axis is provided in the imaging end and controlling the lightness of the image B′″ to produce the image B″″ via adjustment of the light transmittance.

In this preferred embodiment, the image A″ is a P polarized light of the linear polarization while the image B″ is a S polarized light of the linear polarization.

In this preferred embodiment, the image B″ is a S polarized light of the linear polarization while the image A″ is a P polarized light of the linear polarization.

In the preferred embodiment, the timing control unit 51 either transmits a first signal to the first polarization control unit 13, or sends a second signal to the second polarization control unit 23 to control opening and closing of the optical channel.

In the preferred embodiment, the lightness control unit 52 transmits a third signal to the first transmittance control unit 14 or transmits a fourth signal to the second transmittance control unit 24 for adjustment of the light transmittance.

In the preferred embodiment, the first polarization control unit 13 and the second polarization control unit 23 are the structure of a liquid crystal optical switch (not shown in the figure), which respectively control the image of A″ and the image B″ to penetrate the first polarization control unit 13 and the second polarization control unit 23 by the first signal and the second signal from the timing control unit 51.

In the preferred embodiment, the first transmittance control unit 14 and the second transmittance control unit 24 are the structure of a liquid crystal optical switch, which respectively control the lightness (image lightness) of the image A″ and the image B″ by the third signal and the fourth signal.

In the preferred embodiment, the photosensitive module 4 includes a focusing unit 41, a photosensitive unit 42 (such as electrical coupling elements (CCD sensor)).

Furthermore, the structure of a liquid crystal optical switch (not shown in the figure) is a structure including the polarizer, electrode, liquid crystal, electrode and polarizer, if no voltage is applied to the electrodes, a polarized light is able to pass the structure and turn 90 degrees. If the voltage is applied to the electrodes, the polarized light is unable to pass the structure.

In a physical application, the control module 5 is electrically connected to a display module 6 so as to display the images synthesized by the image processing unit 53 (synthesis of the image A″″ and the image B″″) via the display module 6.

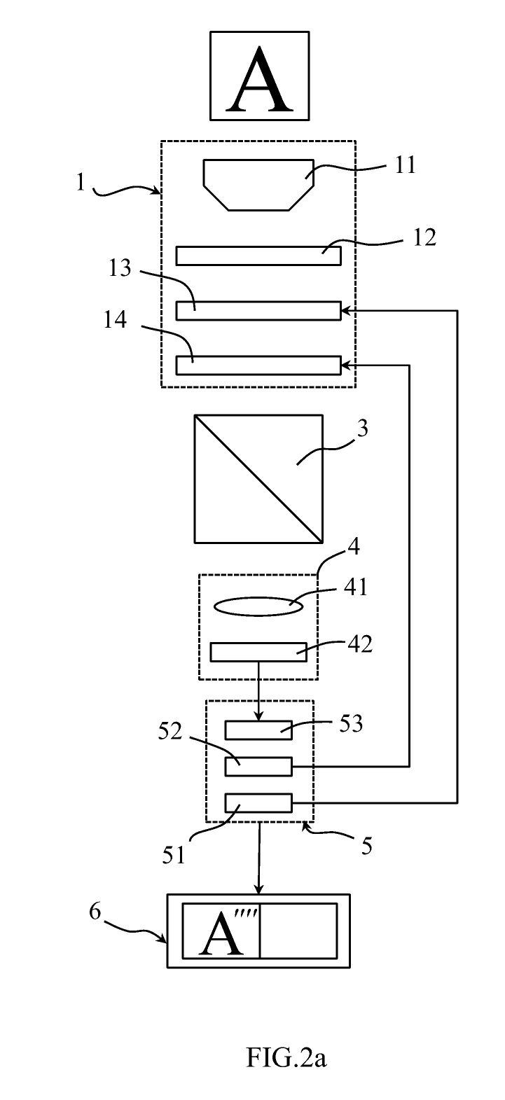

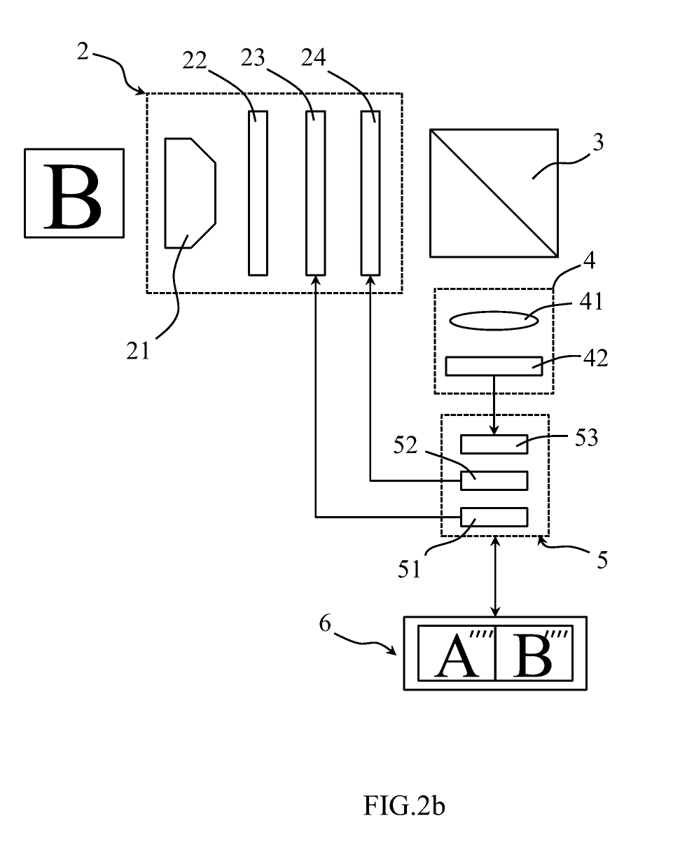

With reference to FIGS. 2a and 2b, the characteristics of the present invention is to alternately operate the channel of the first image capture module 1 and the second image capture module 2, and the detailed description thereof is shown as the following (using the same image code as described in the above description).

### The Imaging of the First Image Capture Module 1:

When the control module 5 controls the timing control unit 51 to transmit the second signal to the second polarization control unit 23 in a time period t₁, the second polarization control unit 23 B″ is ordered to obstruct the imaging channel of the image B″ as the structure shown in FIG. 2a. Then the image A is zoomed by the first lens unit 11, so as to obtain the image A′, which becomes a linearly S-polarized image A″ after passing the first polarization unit 12. Then after the image A″ passes through the first polarization control unit 13, the polarization direction of the image A″ will be rotated 90 degrees to become the image A′″. Then the lightness of the image A′″ is adjusted by the first transmittance control unit 14 according to the third signal transmitted by the control module 5, then image A′″ becomes image A″″.

Since the polarization beam splitter 3 guides the image A″″ to the photosensitive module 4, the image A″″ is focused on the photosensitive unit 42 via the focusing unit 41. After photo sensing, the photosensitive unit 42 transmits the imaging signal to the image processing unit 53, then the imaging signal received within a time t₁ is defined as images A″″.

### The Imaging of the Second Image Capture Module 2:

When the control module 5 controls the timing control unit 51 to transmit the first signal to the first polarization control unit 13 in a time period t₂, the first polarization control unit 13 B″ is ordered to obstruct the imaging channel of the image A″ as the structure shown in FIG. 2b. Then the image B is zoomed by the second lens unit 21, so as to obtain the image B′, which becomes a linearly P-polarized image B″ after passing the second polarization unit 22.

Then after the image A″ passes through the second polarization control unit 23, the polarization direction of the image B″ will be rotated 90 degrees to become the image B′″. Then the lightness of the image B′″ is adjusted by the second transmittance control unit 24 according to the fourth signal transmitted by the control module 5, then image B′″ becomes image B″″. Since the polarization beam splitter 3 guides the image B″″ to the photosensitive module 4, the image A″″ is focused on the photosensitive unit 42 via the focusing unit 41. After photo sensing, the photosensitive unit 42 transmits the imaging signal to the image processing unit 53, then the imaging signal received within a time t₂ is defined as images B″″.

After the above operation, the image processing unit 53 combines image A″″ and image B″″ as a wide-angle image to be displayed on the display module 6.

Since the time periods of t₁ and t₂ are very short, and the response time for opening and closing of the liquid crystal optical switch structure is 30˜50 ms, the vision out of the liquid crystal optical switch structure can-not be observed by the human eyes, so that the wide-angle image screen is continuous. And the time for capturing images can be t₃, t₄, t₅ . . . and so on, so that the first image capture module 1 and the second image capture module 2 can be rapidly alternated to produce a continuous wide angle image.

In fact, different channels will cause unexpected combination of the image A″″ and the image B″″, so that the wide-angle image might be a discontinuous image.

Therefore, the image processing unit 53 allows the lightness control unit 52 to generate the third signal and the fourth signal according to the pixel lightness of the combination by the image A″″ and the image B″″, which causes the first transmittance module 14 and the second transmittance module 24 to adjust the optical transmittance, so as to change the ultimate image lightness of the image A″″ and the image B″″ to obtain the wide-angle image with good lightness balance.

It is to be noted that the multi channel and wide-angle observation system of the present invention captures a wide-view image via the first lens unit 1 and the second lens unit 2. The first polarization control unit 13, the second polarization control unit 23, the first transmittance control unit 14 and the second transmittance control unit 24 are used as the structure of a liquid crystal optical switch to effectively adjust the intensity of light and convert the polarization of the incident light source, and in coordination with the switching of the multi channel via the timing control unit 51, so that the images in the multi channel can be formed in the photosensitive module 4 to achieve a wide-angle image with a balanced vision lightness and without blurry images.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A multi channel and wide-angle observation system comprising:
a first image capture module capturing a first image for zooming, optical modulating and lightness controlling;
a second image capture module capturing a second image for zooming, optical modulating and lightness controlling;
a polarization beam splitter disposed between the first image capture module and the second image capture module, so as to output one of the first image and the second image;
a photosensitive module receiving one of the first image and the second image to generate an imaging signal; and
a control module electrically connected to the photosensitive module, receiving the imaging signal for processing.

2. The multi channel and wide-angle observation system as claimed in claim 1, wherein the first image capture module comprises a first lens unit, a first polarization unit, a first polarization control unit and a first transmittance control unit.

3. The multi channel and wide-angle observation system as claimed in claim 2, wherein the second image capture module comprises a second lens unit, a second polarization unit, a second polarization control unit and a second transmittance control unit.

4. The multi channel and wide-angle observation system as claimed in claim 3, wherein the control module comprises a timing control unit, a lightness control unit and an image processing unit.

5. The multi channel and wide-angle observation system as claimed in claim 4, wherein the timing control unit transmits a first signal to the first polarization control unit to control opening and closing of a first channel.

6. The multi channel and wide-angle observation system as claimed in claim 1, wherein the timing control unit transmits a second signal to the second polarization control unit to control opening and closing of a second channel.

7. The multi channel and wide-angle observation system as claimed in claim 4, wherein the lightness control unit transmits a third signal to adjust a light transmittance of the first transmittance control unit.

8. The multi channel and wide-angle observation system as claimed in claim 4, wherein the lightness control unit transmits a fourth signal to adjust a light transmittance of the first transmittance control unit.

9. The multi channel and wide-angle observation system as claimed in claim 3, wherein the first polarization control unit, the second polarization control unit, the first transmittance control unit and the second transmittance control unit are liquid crystal optical switch structures.

10. The multi channel and wide-angle observation system as claimed in claim 1, wherein the control module is electrically connected to a display module, so as to display the synthesized image via the display module.
